(19) United States
(12) Patent Application Publication
(10) Pub. No.: US 2025/0311886 A1
(43) Pub. Date: Oct. 9, 2025

(54) Automated French Fry Device

(71) Applicant: Patricia Peterson, Elsberry, MO (US)

(72) Inventor: Patricia Peterson, Elsberry, MO (US)

(21) Appl. No.: 18/625,375

(22) Filed: Apr. 3, 2024

(51) Int. Cl. A47J 37/12

(52) U.S. Cl. CPC A47J 37/1228; A47J 37/1219; A47J 37/1261; A47J 37/1266; A47J 37/1295

(57) ABSTRACT

An automated French fry device includes a cooking housing and a plurality of dispensing chutes extending downwardly from the cooking housing. A touch screen is mounted to the cooking housing for ordering French fries. A plurality of hoppers contains French fries and a dispensing unit dispenses a small order of French fries, a medium order of French fries or a large order of French fries. A cooking unit is integrated into the cooking housing to cook the French fries. A box dispenser is attached to the cooking housing to release French fry boxes. A conveyor unit is movably attached the cooking housing to facilitate the employee to receive the small order of French fries, the medium order of French fries or the large order of French fries. Additionally, the touch screen is in communication with the dispensing unit, the cooking unit and the conveyor unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to French fry devices and more particularly pertains to a new french fry device for automatically cooking and dispensing French fries. The device includes a cooking housing and a plurality of hoppers positioned in the cooking housing and a cooking unit positioned beneath the hoppers which receive French fries from the hoppers to cook the French fries. The device includes a box dispenser which dispenses French fry boxes onto a conveyor belt to facilitate the cooked French fries to be dispensed into the French fry boxes for subsequent retrieval by a employee.

### (2) Description of Related Art Including Information Disclosed Under 37 CFR 1.97 and 1.98

The prior art relates to French fry devices including a variety of automated food preparation devices that includes a dispensing device that dispenses food through a vaned fan for inhibiting the food from being damaged and an automated French fry cooker that includes a refrigeration unit for dispensing frozen French fries and a plurality of fry baskets integrated into a fryer and a conveyor for transporting the cooked French fries into a holding bin. In no instance does the prior art disclose an automated French fry cooker that includes a plurality of hoppers for storing uncooked French fries and a plurality of fry baskets that are all contained within a housing and box dispenser for dispensing a box into which cooked French fries are dispensed according to an order placed on a touch screen.

### BRIEF SUMMARY OF THE INVENTION

An embodiment of the disclosure meets the needs presented above by generally comprising a cooking housing and a plurality of dispensing chutes extending downwardly from the cooking housing. A touch screen is mounted to the cooking housing for ordering French fries. A plurality of hoppers contains French fries and a dispensing unit dispenses a small order of French fries, a medium order of French fries or a large order of French fries. A cooking unit is integrated into the cooking housing to cook the French fries. A box dispenser is attached to the cooking housing to release French fry boxes. A conveyor unit is movably attached the cooking housing to facilitate the employee to receive the small order of French fries, the medium order of French fries or the large order of French fries. Additionally, the touch screen is in communication with the dispensing unit, the cooking unit and the conveyor unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an embodiment of the disclosure.

FIG. 2 is a back perspective view of an embodiment of the disclosure.

FIG. 3 is a top perspective view of an embodiment of the disclosure.

FIG. 4 is a front phantom view of an embodiment of the disclosure.

FIG. 5 is a back phantom view of an embodiment of the disclosure.

FIG. 6 is a left side cut-away view of an automated French fry device according an embodiment of the disclosure showing French fries being released from a hopper into a fry basket.

FIG. 7 is a left side cut-away view of an embodiment of the disclosure showing a fry basket being lowered into an oil reservoir.

FIG. 8 is a left side cut-away view of an embodiment of the disclosure showing cooked French fries being dispensed from a fry basket.

FIG. 9 is a cross sectional view taken along line 9-9 of FIG. 4 of an embodiment of the disclosure.

FIG. 10 is a schematic view of an embodiment of the disclosure.

FIG. 11 is a cross sectional view taken along line 11-11 of FIG. 5 of an embodiment of the disclosure.

### DETAILED DESCRIPTION OF THE INVENTION

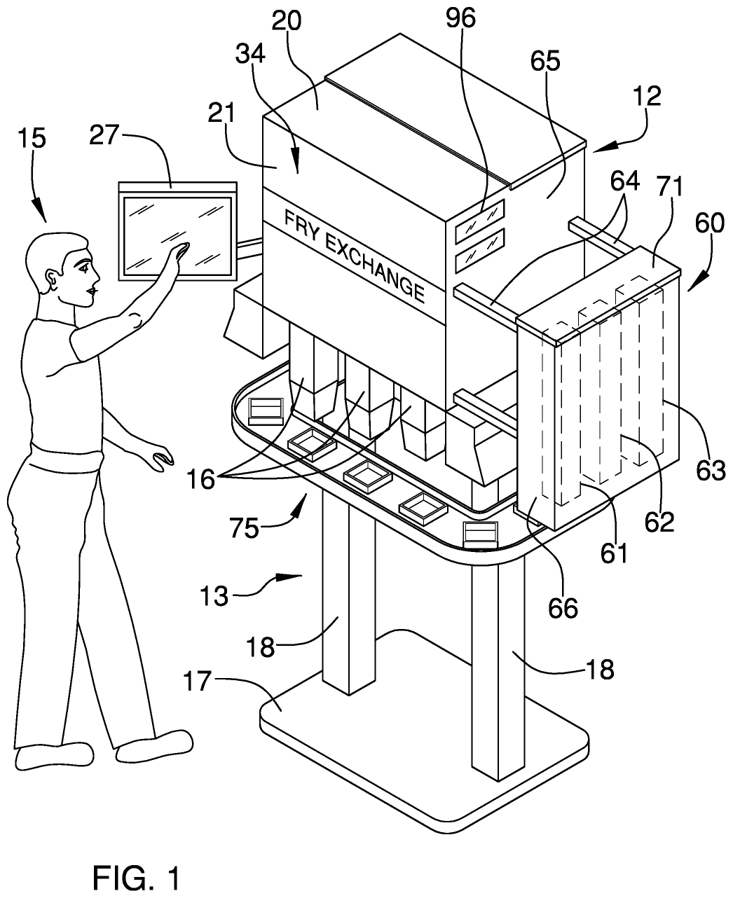

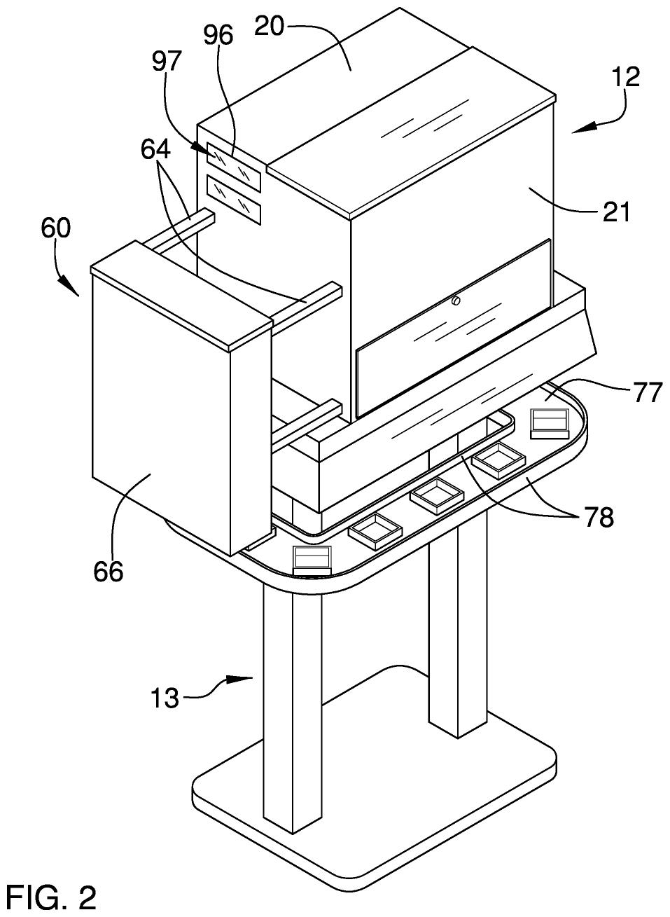

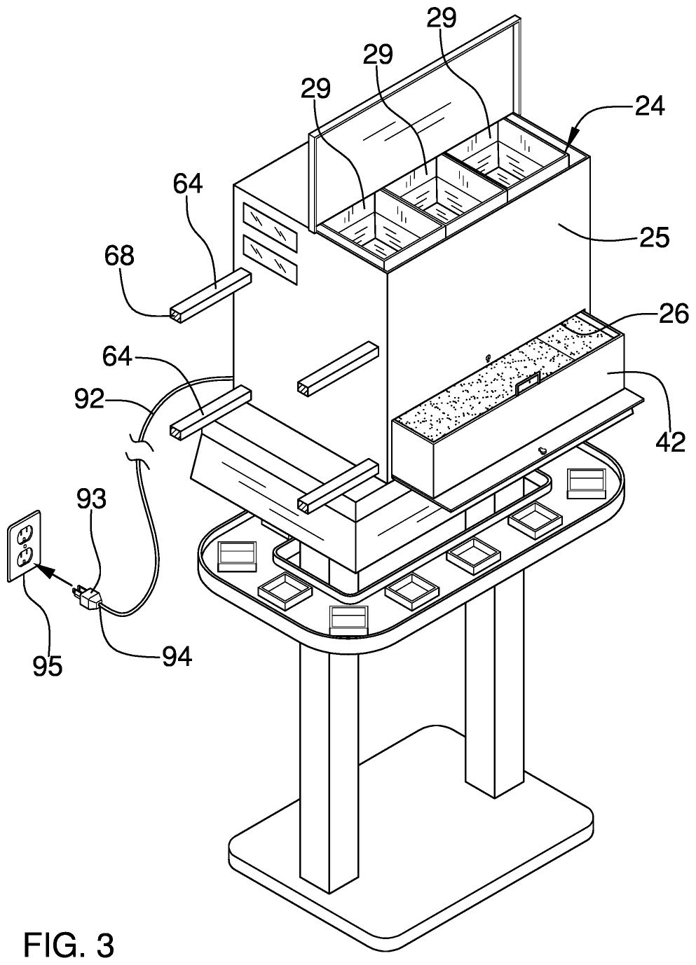

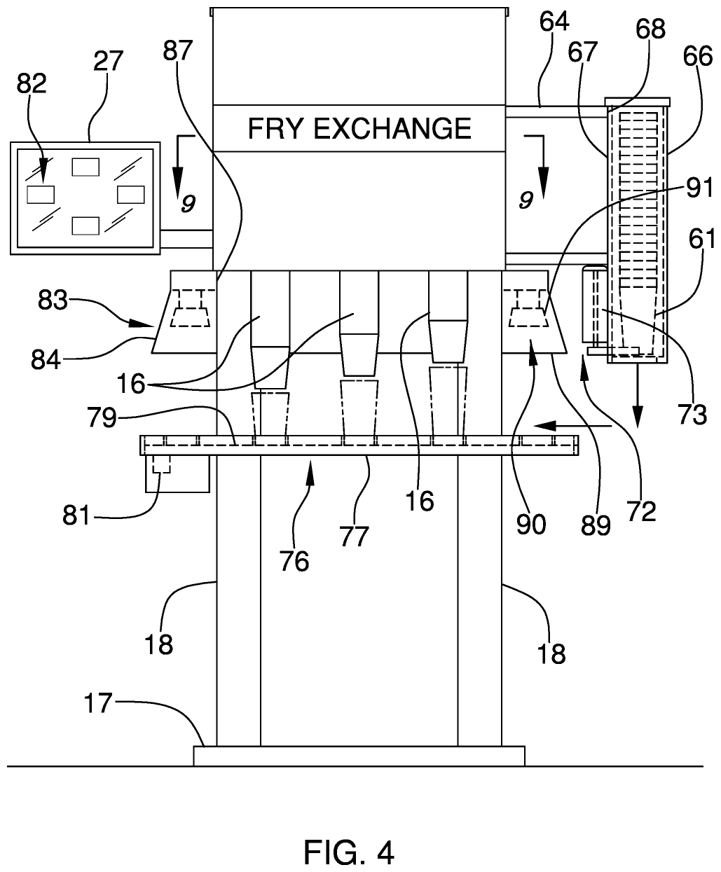

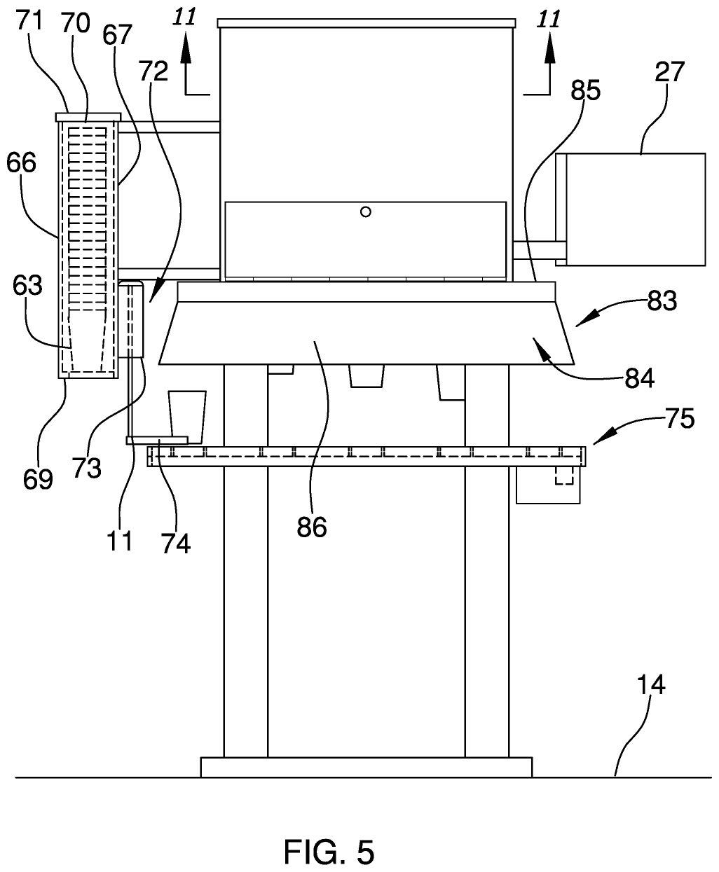

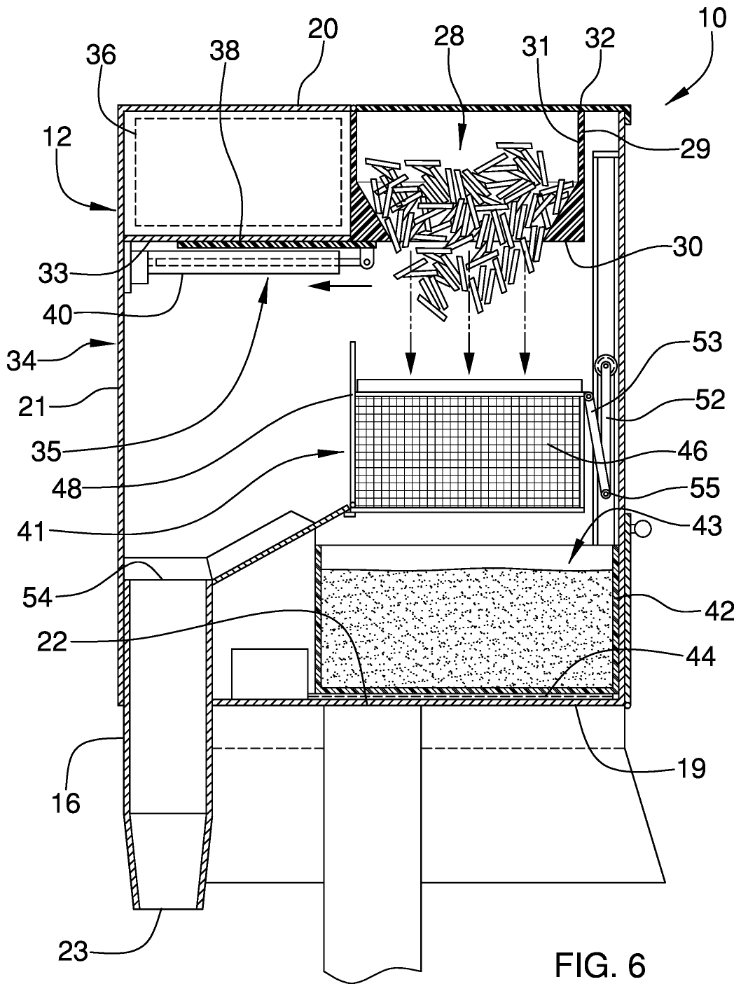

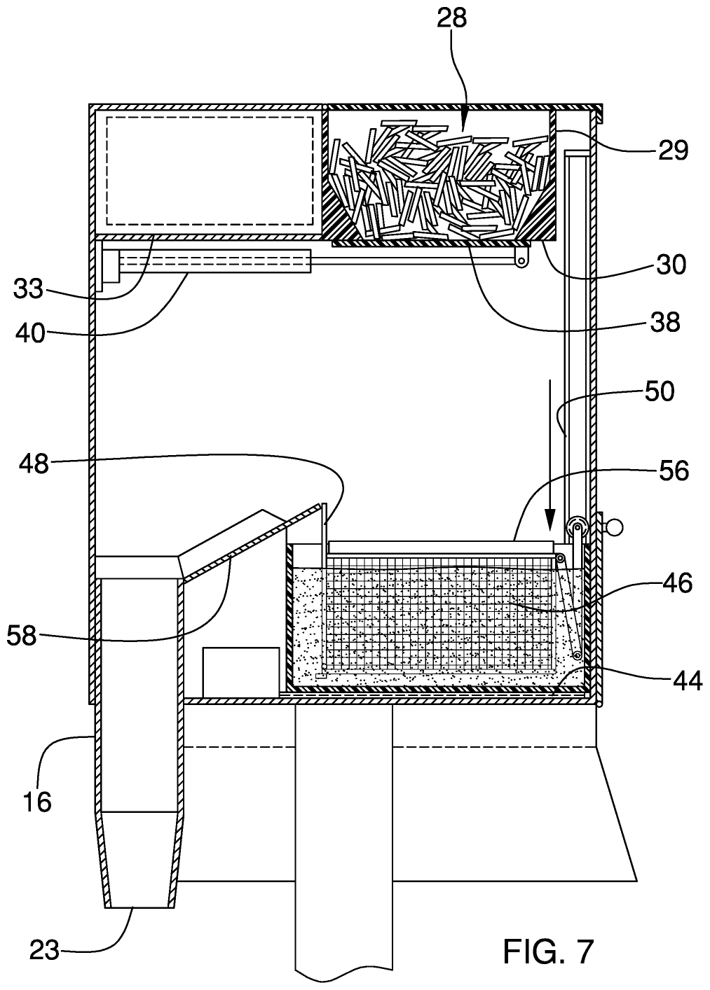

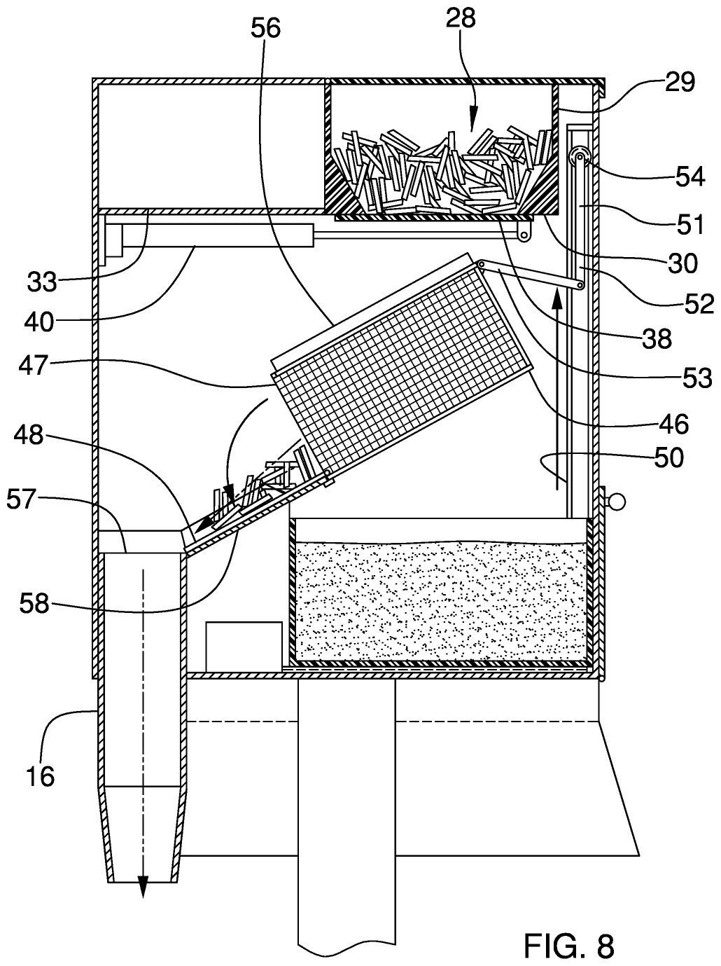

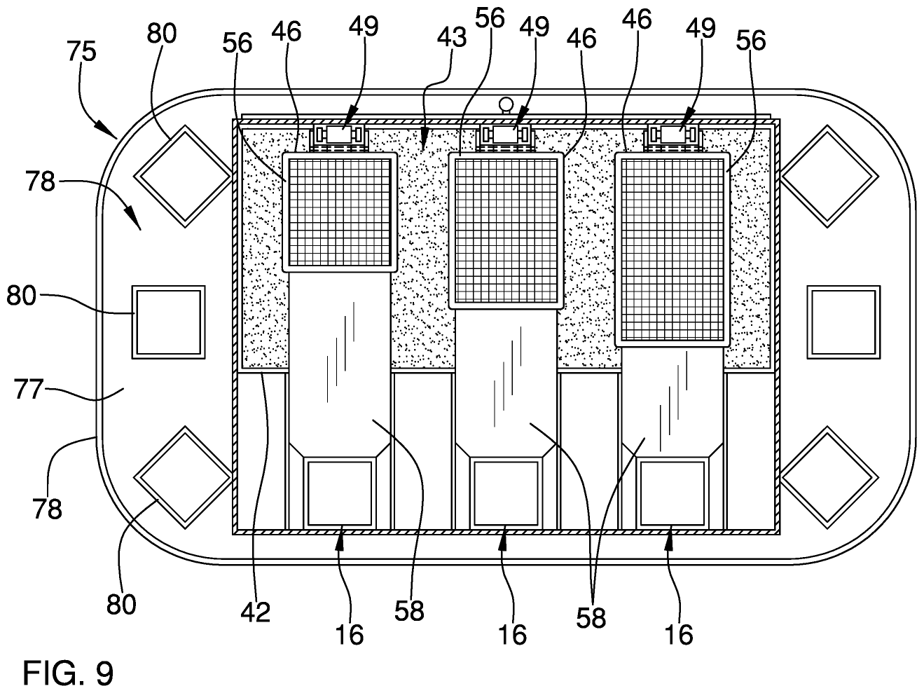

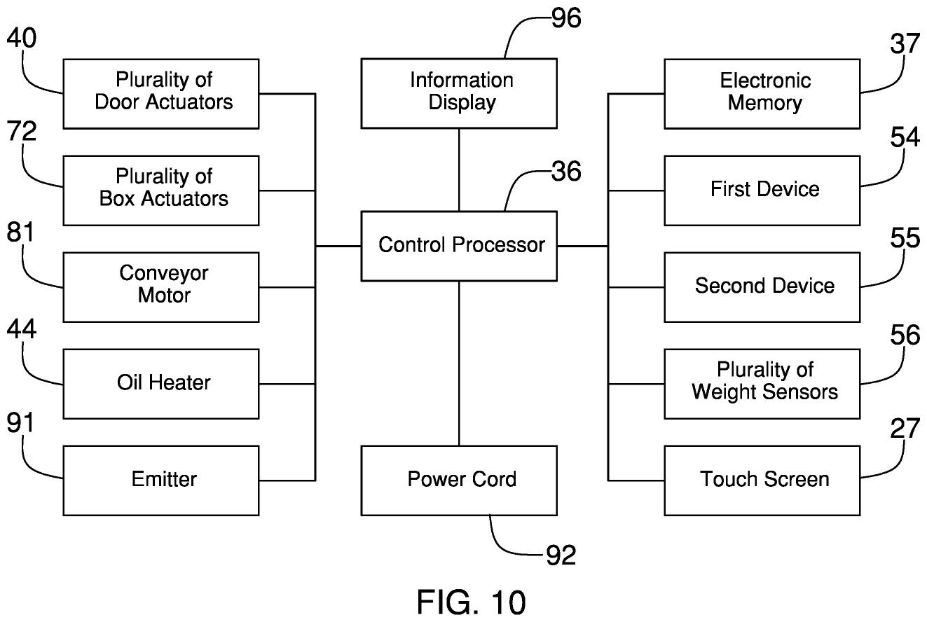

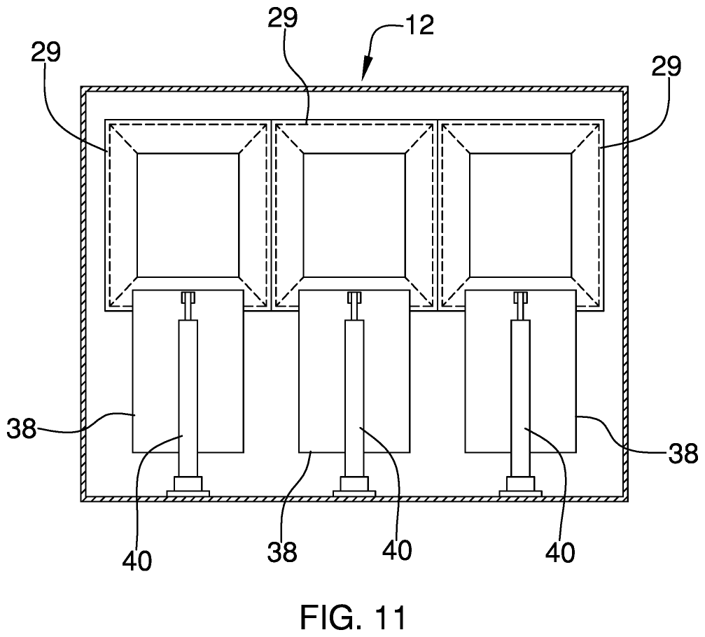

With reference now to the drawings, and in particular to FIGS. 1 through 11 thereof, a new French fry device embodying the principles and concepts of an embodiment of the disclosure and generally designated by the reference numeral 10 will be described.

As best illustrated in FIGS. 1 through 11, the automated French fry device 10 generally comprises a cooking housing 12 that is mounted upon a stand 13 thereby facilitating the stand 13 to support the cooking housing 12 over a horizontal support surface 14, such a floor in a restaurant or other type of location where a employee 15 would place an order for food. The cooking housing 12 has a plurality of dispensing chutes 16 each extending downwardly from the cooking housing 12 and the stand 13 comprises a base 17 and a pair of legs 18 each extending upwardly from the base 17. The cooking housing 12 has a bottom wall 19, a top wall 20 and an outer wall 21 extending between the top wall 20 and the bottom wall 19 and the bottom wall 19 is attached to a top end 22 of the pair of legs 18. Each of the plurality of dispensing chutes 16 extends through the bottom wall 19 of the cooking housing 12 such that a distal end 23 of each of the plurality of dispensing chutes 16 is positioned beneath the bottom wall 19. Furthermore, each of the plurality of dispensing chutes 16 has a unique length with respect to each other. The top wall 20 has an access opening 24 extending into an interior of the cooking housing 12 and a back side 25 of the outer wall 21 has an oil opening 26 extending into the interior of the cooking housing 12.

A touch screen 27 is mounted to the cooking housing 12 and the touch screen 27 can be manipulated by the employee 15 for monitoring the cooking of the French fries 28. A plurality of hoppers 29 is each positioned inside of the cooking housing 12; each of the plurality of hoppers 29 contains French fries 28 and the French fries 28 comprise uncooked French fries that may be frozen or otherwise prepared for subsequent cooking. Each of the plurality of hoppers 29 is aligned with the access opening 24 in the top wall 20 of the cooking housing 12 to facilitate each of the plurality of hoppers 29 to be filled with French fries 28. Each of the hoppers 29 has a bottom end 30 that is open such that the bottom end 30 of each of the plurality of hoppers 29 can dispense the French fries 28. An interior surface 31 of each of the plurality of hoppers 29 tapers inwardly adjacent to the bottom end 30 to enhance efficiency of releasing the French fries 28 from the plurality of hoppers 29. Additionally, each of the plurality of hoppers 29 has a top end 32 that is open such that the top end 32 of each of the plurality of hoppers 29 can receive the French fries 28. Furthermore, each of the plurality of hoppers 29 is maintained at a temperature below the freezing point of water thereby facilitating the French fries 28 to remain frozen while the French fries are stored in the hoppers 29.

A control housing 33 is positioned within the cooking housing 12 and the control housing 33 is positioned between the plurality of hoppers 29 and a front side 34 of the outer wall 21 of the cooking housing 12. A dispensing unit 35 is integrated into the cooking housing 12 and the dispensing unit 35 is in communication with each of the plurality of hoppers 29. The dispensing unit 35 is actuatable to dispense a small order of French fries 28, a medium order of French fries 28 or a large order of French fries 28 from a respective one of the plurality of hoppers 29. The dispensing unit 35 comprises a control processor 36 that is positioned within the control housing 33 and the control processor 36 receives a small input, a medium input, a large input and a close input. Furthermore, the control processor 36 includes an electronic memory 37 which stores a small weight, a medium weight and a large weight.

The dispensing unit 35 includes a plurality of hopper doors 38 each slidably positioned on a lower wall 39 of the control housing 33. Each of the hopper doors 38 is aligned with the bottom end 30 of a respective one of the plurality of hoppers 29. Each of the plurality of hopper doors 38 is positionable in a closed position having each of the plurality of hopper doors 38 extending across the bottom end 30 of a respective one of the plurality of hoppers 29 to inhibit the French fries 28 from being dispensed from the respective hopper 29. Each of the plurality of hopper doors 38 is positionable in an open position having the each of the plurality of hopper doors 38 being displaced from the bottom end 30 of the respective hopper 29. In this way each of the plurality of hopper doors 38 facilitates the French fries 28 to be dispensed from the bottom end 30 of the respective hopper 29.

The dispensing unit includes a plurality of door actuators 40 and each of the door actuators 40 is mounted in the cooking housing 12. Each of the plurality of door actuators 40 is positioned beneath a respective one of the plurality of hopper doors 38 and each of the door actuators 40 is coupled to a respective one of the hopper doors 38. Additionally, each of the door actuators 40 is electrically coupled to the control processor 36. Each of the plurality of door actuators 40 is individually actuatable into an opening condition such that door actuator that is actuated into the opening condition urges the respective hopper 29 door into the open position. Additionally, each of the plurality of door actuators 40 is individually actuatable into a closing condition such that the door actuator 40 that is actuated into the closing condition urges the respective hopper 29 door into the closed position. Each of the door actuators 40 may comprise a hydraulic piston, an electromechanical linear actuator or other type of actuator that can urge the hopper doors 38 back and forth.

A cooking unit 41 is provided and the cooking unit 41 is integrated into the cooking housing 12. The cooking unit 41 receives the small order of French fries 28, the medium order of French fries 28 or the large order of French fries 28 from the dispensing unit 35 thereby facilitating the cooking unit 41 to cook the small order of French fries 28, the medium order of French fries 28 or the large order of French fries 28. The cooking unit 41 is actuated to release the small order of French fries 28, the medium order of French fries 28 or the large order of French fries 28 into the a respective one of the plurality of dispensing chutes 16.

The cooking unit 41 comprises an oil reservoir 42 that is slidably positioned in the cooking housing 12 and the oil reservoir 42 contains cooking oil 43. The oil reservoir 42 is aligned with the oil opening 26 in the back side 25 of the outer wall 21 of the cooking housing 12 such that the oil reservoir 42 is slidable outwardly through the oil opening 26 for filling or servicing the oil reservoir 42. Additionally, the oil reservoir 42 is positioned beneath the plurality of hoppers 29. The cooking unit 41 includes an oil heater 44 that is attached to the bottom wall 19 of the cooking housing 12 such that the oil heater 44 is positioned inside of the cooking housing 12. The oil reservoir 42 lies on the oil heater 44 when the oil reservoir 42 is positioned in the cooking housing 12. Additionally, the oil heater 44 is in thermal communication with a bottom wall 45 of the oil reservoir 42 when the oil reservoir 42 is positioned on the oil heater 44 thereby facilitating the oil heater 44 to heat the oil reservoir 42 such that the oil heater 44 heats the cooking oil 43 in the oil reservoir 42. The oil heater 44 is electrically coupled to the control processor 36 and the oil heater 44 may comprise an electric oil heater or the like and the oil heater 44 may have an operational temperature ranging between approximately 300.0 degrees Fahrenheit and 400.0 degrees Fahrenheit.

The cooking unit 41 includes a plurality of fry baskets 46 and each of the plurality of fry baskets 46 is slidably positioned within the cooking housing 12. Each of the plurality of fry baskets 46 is positioned beneath a respective one of the plurality of hoppers 29 to receive the French fries 28 from the respective hopper 29. Each of the plurality of fry baskets 46 has a forward side 47 that is open and each of the plurality of fry baskets 46 has a fry door 48 that is hingedly disposed on the forward side 47. The fry door 48 is positionable in an open position to release the French fries 28 from the forward side 47. The fry door 48 is positionable in a closed position to inhibit the French fries 28 from passing through the forward side 47. Additionally, the plurality of fry baskets 46 has a unique size with respect to each other ranging between a small size, a medium size and a large size.

The cooking unit includes a plurality of basket transports 49 and each of the plurality of basket transports 49 is positioned within the cooking housing 12. Each of the plurality of fry baskets 46 is attached to a respective one of the plurality of basket transports 49 for lowering the respective fry basket 46 into the oil reservoir 42. In this way the respective fry basket 46 can cook the French fries 28 in the oil reservoir 42. The plurality of basket transports 49 is spaced apart from each other and is evenly distributed along the back side 25 of the outer wall 21 of the cooking housing 12.

Each of the plurality of basket transports 49 comprises a basket track 50 that is mounted to the back side 25 of the outer wall 21 of the cooking housing 12 such that the basket track 50 is positioned within the cooking housing 12. The basket track 50 is oriented to extend between a respective one of the plurality of fry baskets 46 and a respective one of the plurality of hoppers 29. Each of the plurality of basket transports 49 includes a basket actuator 51 which including a first arm 52 that is pivotally coupled to a second arm 53 and the second arm 53 is pivotally attached to a respective one of the fry baskets 46. The basket actuator 51 includes a first drive 54 that is attached to the first arm 52 having the first drive 54 being positioned in the basket track 50 and the first drive 54 is electrically coupled to the control processor 36.

The first drive 54 is actuated to either lift or lower the first arm 52 along the backet track thereby lifting the respective fry basket 46 out of the cooking oil 43 or lowering the respective fry basket 46 into the cooking oil 43. The basket actuator 51 includes a second drive 55 that is attached to the second arm 53 and the second drive 55 is electrically coupled to the control processor 36. The second drive 55 urges the second arm 53 between a cooking position and a dumping position. The second arm 53 angles upwardly from the first arm 52 when the second arm 53 is in the cooking position thereby positioning the respective fry basket 46 in a horizontal orientation. Furthermore, the second arm 53 angles forwardly from the first arm 52 when the second arm 53 is in the dumping position thereby positioning the respective fry basket 46 in a downwardly sloped position. The fry door 48 on the respective fry basket 46 is urged into the open position when the second arm 53 is positioned in the dumping position and the fry door 48 on the respective fry basket 46 is biased into the closed position when the second arm 53 is positioned in the cooking position.

A plurality of weight sensors 56 is provided and each of the plurality of weight sensors 56 is attached to a respective one of the plurality of fry baskets 46 thereby facilitating each of the weight sensors 56 to sense the weight of the respective fry basket 46. In this way each of the plurality of weight sensors 56 can sense the combined weight of the respective fry basket 46 and the French fries 28 released into the respective fry basket 46. Each of the plurality of weight sensors 56 is electrically coupled to the control processor 36. Additionally, each of the plurality of weight sensors 56 may comprise an electronic weight sensor which has an operational sensitivity ranging between approximately 0.4 and 2.5 kg.

The door actuator 40 that is aligned with the small size fry basket 46 is actuated into the open condition when the control processor 36 receives the small input thereby facilitating the small size fry basket 46 to be filled with French fries 28. The door actuator 40 aligned with the small size fry basket 46 is actuated into the closed condition when the control processor 36 receives the close input. The control processor 36 receives the close input when the weight sensor 56 attached to the small size fry basket 46 senses the combined weight of the small size fry basket 46 and the French fries 28 reaches the small weight stored in the electronic memory 37.

The door actuator 40 that is aligned with the medium size fry basket 46 is actuated into the open condition when the control processor 36 receives the medium input. In this way the medium size fry basket 46 can be filled with French fries 28. The door actuator 40 aligned with the medium size fry basket 46 is actuated into the closed condition when the control processor 36 receives the close input. Additionally, the control processor 36 receives the close input when the weight sensor 56 attached to the medium size fry basket 46 senses the combined weight of the medium size fry basket 46 and the French fries 28 reaches the medium weight stored in the electronic memory 37.

The door actuator 40 that is aligned with the large size fry basket 46 is actuated into the open condition when the control processor 36 receives the large input. In this way the large size fry basket 46 can be filled with French fries 28. The door actuator 40 aligned with the large size fry basket 46 is actuated into the closed condition when the control processor 36 receives the close input. Additionally, the control processor 36 receives the close input when the weight sensor 56 attached to the large size fry basket 46 senses the combined weight of the large size fry basket 46 and the French fries 28 reaches the large weight stored in the electronic memory 37.

Each of the plurality of dispensing chutes 16 extends downwardly from the bottom wall 19 of the cooking housing 12. Additionally, each of the dispensing chutes 16 is aligned with a respective one of the fry baskets 46 such that each of the plurality of dispensing chutes 16 can receive the French fries 28 from the respective fry basket 46. Each of the dispensing chutes 16 extends upwardly through the bottom wall 19 of the cooking housing 12 such that an upper end 57 of each of the plurality of dispensing chutes 16 is positioned inside of the cooking housing 12. Additionally, each of the plurality of dispensing chutes 16 includes a ramp 58 which angles between the upper end 57 and the respective fry basket 46. In this way the ramp 58 on a respective dispensing chute 16 can direct the French fries 28 from the respective fry basket 46 into the respective dispensing chute 16. Each of the plurality of dispensing chutes 16 is tapered adjacent to the distal end 23 of the plurality of dispensing chutes 16. The dispensing chutes 16 are spaced apart from each other and are distributed along the front side 34 of the outer wall 21 of the cooking housing 12.

A box dispenser 60 is provided and the box dispenser 60 is attached to the cooking housing 12. The box dispenser 60 contains a plurality of small boxes 61, a plurality of medium boxes 62 and a plurality of large boxes 63. The box dispenser 60 releases one of the small boxes 61, one of the medium boxes 62 or one of the large boxes 63 depending upon the order that is placed. In this way the small box 61, the medium box 62 or the large box 63 can receive the small order of French fries 28, the medium order of French fries 28 or the large order of French fries 28. Additionally, the plurality of large boxes 63 might includes a basket size box which would be approximately equivalent to two of the medium boxes 62.

The box dispenser 60 comprises a plurality of supports 64 and each of the supports 64 is coupled to and extends away from a first lateral side 65 of the outer wall 21 of the cooking housing 12. The box dispenser 60 includes a box housing 66 that has a rear wall 67 which is attached to a distal end 68 of each of the plurality of supports 64 such that the box housing 66 is spaced from the cooking housing 12. The box housing 66 has a bottom end 69 that is open into an interior of the box housing 66 and the box housing 66 has a top end 70 that is open into the interior of the box housing 66 thereby facilitating the box housing 66 to be filled with a stack of the small boxes 61, a stack of the medium boxes 62 and a stack of the large boxes 63. Additionally, the box housing 66 has a lid 71 that is movably disposed on the top end 70 of the box housing 66 for opening and closing the top end 70 of the box housing 66.

The box dispenser 60 includes a plurality of box actuators 72 that is each attached to the rear wall 67 of the box housing 66 and each of the plurality of box actuators 72 is electrically coupled to the control processor 36. Each of the plurality of box actuators 72 is aligned with a respective one of the stack of small boxes 61, the stack of medium boxes 62 or the stack of large boxes 63. Additionally, each of the plurality of the box actuators 72 includes a piston 73 which is urgeable downwardly from a respective box actuator 72 when the respective box actuator 72 is actuated into a first condition. Each of the plurality of box actuators 72 includes a grip 74 which is attached to a distal end 11 of the piston 73 of a respective box actuator 72.

The grip 74 of each of the plurality of box actuators 72 engages a bottommost one of a respective one of the stack of small boxes 61 or the stack of medium boxes 62 or the stack of large boxes 63 when a respective box actuator 72 is actuated into a second condition. Additionally, the piston 73 of a respective box actuator 72 is rotated to position the grip 74 in a releasing position when the respective box actuator 72 is actuated into a third condition. Each of the plurality of box actuators 72 may comprise an electronic linear actuator or the like which additionally has rotational capabilities. Furthermore, the grip 74 associated with each box actuator 72 might comprise a mechanized claw that can open and close for engaging and subsequently releasing the small box 61 or medium box 62 or large box 63.

A conveyor unit 75 is movably attached to the stand 13 and the conveyor unit 75 is positioned beneath the cooking housing 12. The conveyor unit 75 receives the small box 61, the medium box 62 or the large box 63 that is released from the box dispenser 60. Furthermore, the conveyor unit 75 is aligned with the plurality of dispensing chutes 16 thereby facilitating the small box 61, the medium box 62 or the large box 63 to receive a corresponding one of the small order of French fries 28, the medium order of French fries 28 or the large order of French fries 28 from a respective one of the dispensing chutes 16. In this way the conveyor unit 75 facilitates the employee 15 to receive the small order of French fries 28, the medium order of French fries 28 or the large order of French fries 28.

The conveyor unit 75 comprises a track support 76 that is continuous such that the track support 76 forms a closed loop. The track support 76 has a basal wall 77 and a pair of outer walls 78 extending upwardly from the basal wall 77 and the track support 76 extends around the stand 13 having each of the outer walls 78 being directed upwardly toward the cooking housing 12. The conveyor unit 75 includes a conveyor belt 79 that is positioned on the basal wall 77 of the track support 76 and the conveyor belt 79 is continuous such that the conveyor belt 79 extends around the closed loop defined by the track support 76. The conveyor unit 75 includes a plurality of boxes 80 that is each coupled to and extends upwardly from the conveyor belt 79. The boxes 80 are spaced apart from each other and are evenly distributed along the conveyor belt 79. A respective one of the plurality of box actuators 72 places a respective one of the small box 61, the medium box 62 or the large box 63 into a respective one of the boxes 80 on the conveyor belt 79 thereby facilitating the conveyor belt 79 to transport the respective small box 61 or medium box 62 or large box 63 around the cooking housing 12. The conveyor unit 75 includes a conveyor motor 81 that is attached to the track support 76 and the conveyor motor 81 is in mechanical communication with the conveyor belt 79. The conveyor motor 81 urges the conveyor belt 79 to travel around the track support 76 when the conveyor motor 81 is turned on. Additionally, the conveyor motor 81 is electrically coupled to the control processor 36 and the conveyor motor 81 may comprise an electric motor or the like.

The touch screen 27 is in communication with each of the dispensing unit 35, the cooking unit 41 and the conveyor unit 75 thereby facilitating the employee 15 to monitor cooking of the small order of French fries 28, the medium order of French fries 28 or the large order of French fries 28. Additionally, the touch screen 27 displays indicia 82 comprising a plurality of words and icons associated with the small order of French fries 28, the medium order of French fries 28 and the large order of French fries 28. Furthermore, the plurality of words and icons facilitate the employee 15 to monitor all aspects of the cooking of the small order of French fries 28, the medium order of French fries 28 or the large order of French fries 28.

The touch screen 27 is electrically coupled to the control processor 36 and the control processor 36 receives the small input when the touch screen 27 is employed to order a small order of French fries 28. The control processor 36 receives the medium input when the touch screen 27 is employed to order a medium order of French fries 28 and the control processor 36 receives the large input when the touch screen 27 is employed to order a large order of French fries 28. The touch screen 27 may comprise a light emitting diode touch screen or other type of electronic touch screen that is capable of displaying color imagery and which is sensitive to touch. Furthermore, the touch screen 27 may include point of sale capabilities to facilitate the employee 15 to pay for the order of French fries 28, including but not being limited to, a credit card reader or other means of electronic payment system that is commonly employed in a retail environment. The control processor 36 may be in communication with a point of sale device that is accessible to a customer of the restaurant to facilitate the customer to place the order for French fries 28 rather than having the employee 15 place the order for the French fries 28 on the touch screen 27. In the event that a plurality of cooking housings 12 are located in the same location, each of the plurality of cooking housings 12 is assigned a unique identity with respect to each other in the point of sale to ensure each of the plurality of cooking housings 12 can operate independently of each other. Additionally, the cooking housing 12 may be positioned on a floor mat to keep horizontal support surface 14 free from debris.

A heat lamp 83 is attached to the cooking housing 12 and the heat lamp 83 is elongated to extend around a full perimeter of the cooking housing 12. The heat lamp 83 is positioned above the conveyor unit 75 and the heat lamp 83 emits infra-red radiation onto the French fries 28 that are transported by the conveyor unit 75 for retaining the French fries 28 on the conveyor unit 75 at a preferred temperature. The heat lamp 83 includes a lamp housing 84 that has a top wall 85 and an outside wall 86 extending downwardly from the top wall 85 of the lamp housing 84. A rear edge 87 of the top wall 85 is attached to the outer wall 21 of the cooking housing 12 having the top wall 85 of the lamp housing 84 extending around the outer wall 21 of the cooking housing 12.

The outside wall 86 of the lamp housing 84 angles away from the outer wall 21 of the cooking housing 12. The outside wall 86 of the lamp housing 84 has a lower edge 89 defines an opening 90 into the lamp housing 84 that is directed toward the conveyor belt 79. The heat lamp 83 includes an emitter 91 that is disposed within the lamp housing 84 which emits infra-red radiation outwardly through the opening 90 defined in the lamp housing 84. The emitter 91 is electrically coupled to the control processor 36 and the emitter 91 may comprise an infra-red light emitter of any conventional design that is commonly employed for warming food. A power cord 92 is coupled to and extends away from the control housing 33 and the power cord 92 is electrically coupled to the control processor 36. The power cord 92 has a male plug 93 that is electrically coupled to a distal end 94 of the power cord 92. The male plug 93 can be plugged into a power source 95 comprising a female electrical outlet.

The cooking unit 41 includes an information display 96 that is integrated into the first lateral side 65 of the outer wall 21 of the cooking housing 12 and the information display 96 is electrically coupled to the control processor 36. The information display 96 displays indica 97 comprising numbers to indicate the temperature of the cooking oil 43 in the oil reservoir 42 as well as numbers to indicate the time remaining for the French fries 28 to be cooked in each of the respective fry baskets 46. Additionally, the indicia 97 displayed on the information display 96 includes a reminder to change the cooking oil 43 at regularly scheduled intervals and additional reminders for maintenance and upkeep of the cooking unit 41. The information display 96 may comprise a light emitting diode display or other type of electronic display.

In use, each of the plurality of hoppers 29 is filled with the uncooked French fries 28 and the oil reservoir 42 is filled with the cooking oil 43. The employee 15 approaches the touch screen 27 to place an order for a small order of French fries 28, a medium order of French fries 28 or a large order of French fries 28. The associated hopper 29 releases the appropriate amount of uncooked French fries 28 into the respective fry basket 46 and the respective fry basket 46 is lowered into the cooking oil 43 to fry the uncooked French fries 28. The box dispenser 60 dispenses either a small box 61 or a medium box 62 or a large box 63, depending on the order placed by the employee 15, for the order of French fries 28 and the small box 61 or medium box 62 or large box 63 is transported along the conveyor belt 79 to be positioned beneath the appropriate dispensing chute 16. The subsequently cooked French fries 28 are released from the respective fry basket 46 such that the cooked French fries 28 are deposited into the small box 61 or the medium box 62 or the large box 63 and the conveyor belt 79 then begins transporting the small box 61 or the medium box 62 or the large box 63 around the cooking housing 12 until the employee 15 retrieves the small box 61 or the medium box 62 or the large box 63 from the conveyor belt 79. In this way the order of French fries 28 is automatically cooked for the employee 15 and subsequently dispensed for the employee 15 to retrieve.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated French fry device for cooking and dispensing French fries based on a employee's input, said device comprising:
a cooking housing being mounted upon a stand wherein said stand is configured to support said cooking housing over a support surface, said cooking housing having a plurality of dispensing chutes each extending downwardly from said cooking housing;
a touch screen being mounted to said cooking housing wherein said touch screen is configured to be touched by a employee for ordering French fries;
a plurality of hoppers, each of said plurality of hoppers being positioned inside of said cooking housing wherein each of said plurality of hoppers is configured to contain French fries;
a dispensing unit being integrated into said cooking housing, said dispensing unit being in communication with each of said plurality of hoppers, said dispensing unit being actuatable to dispense a small order of French fries or a medium order of French fries or a large order of French fries from a respective one of said plurality of hoppers;
a cooking unit being integrated into said cooking housing, said cooking unit receiving said small order of French fries or said medium order of French fries or said large order of French fries from said dispensing unit thereby facilitating said cooking unit to cook said small order of French fries or said medium order of French fries or said large order of French fries, said cooking unit being actuated to release said small order of French fries or said medium order of French fries or said large order of French fries into said a respective one of said plurality of dispensing chutes;
a box dispenser being attached to said cooking housing, said box dispenser containing a plurality of small boxes and a plurality of medium boxes and a plurality of large boxes, said box dispenser releasing one of said small boxes or one of said medium boxes or one of said large boxes depending upon the order that is entered on said touch screen thereby facilitating said small box or said medium box or said large box to receive said small order of French fries or said medium order of French fries or said large order of French fries;
a conveyor unit being movably attached to said stand, said conveyor unit being positioned beneath said cooking housing, said conveyor unit receiving said small box or said medium box or said large box released from said box dispenser, said conveyor unit being aligned with said plurality of dispensing chutes thereby facilitating said small box or said medium box or said large box to receive a corresponding one of said small order of French fries or said medium order of French fries or said large order of French fries from a respective one of said dispensing chutes wherein said conveyor unit is configured to facilitate the employee to receive said small order of French fries or said medium order of French fries or said large order of French fries; and
wherein said touch screen is in communication with each of said dispensing unit and said and said cooking unit and said conveyor unit wherein said touch screen is configured to facilitate the employee to order and subsequently receive said small order of French fries or said medium order of French fries or said large order of French fries.

2. The device according to claim 1, wherein:
said stand comprises a base and a pair of legs each extending upwardly from said base;
said cooking housing has a bottom wall, a top wall and an outer wall extending between said top wall and said bottom wall;
said bottom wall is attached to a top end of said pair of legs;
each of said plurality of dispensing chutes extends through said bottom wall of said cooking housing such that a distal end of each of said plurality of dispensing chutes is positioned beneath said bottom wall;
each of said plurality of dispensing chutes has a unique length with respect to each other;
said top wall has an access opening extending into an interior of said cooking housing; and
a back side of said outer wall has an oil opening extending into said interior of said cooking housing.

3. The device according to claim 2, wherein:
each of said plurality of hoppers is aligned with said access opening in said top wall of said cooking hopper wherein said access opening is configured to facilitate each of said plurality of hoppers to be filled with French fries;
each of said hoppers has a bottom end being open wherein said bottom end of each of said plurality of hoppers is configured to dispense the French fries;
an interior surface of each of said plurality of hoppers tapers inwardly adjacent to said bottom end wherein said interior surface of each of said plurality of hoppers is configured to enhance efficiency of releasing the French fries from said plurality of hoppers; and
each of said plurality of hoppers has a top end being open wherein said top end of each of said plurality of hoppers is configured to receive the French fries.

4. The device according to claim 2, wherein:
said device includes a control housing being positioned within said cooking housing; and
said control housing is positioned between said plurality of hoppers and a front side of said outer wall of said cooking housing; and
said dispensing unit comprises:
a control processor being positioned within said control housing, said control processor receiving a small input and a medium input and a large input and a close input, said control processor including an electronic memory which stores a small weight and a medium weight and a large weight;
a plurality of hopper doors, each of said hopper doors being slidably positioned on a lower wall of said control housing, each of said hopper doors being aligned with said bottom end of a respective one of said plurality of hoppers, each of said plurality of hopper doors being positionable in a closed position having each of said plurality of hopper doors extending across said bottom end of a respective one of said plurality of hoppers wherein said plurality of hopper doors is configured to inhibit the French fries from being dispensed from said respective hopper, each of said plurality of hopper doors being positionable in an open position having said each of said plurality of hopper doors being displaced from said bottom end of said respective hopper wherein said each of said plurality of hopper doors is configured to facilitate the French fries to be dispensed from said bottom end of said respective hopper; and
a plurality of door actuators, each of said door actuators being mounted in said cooking housing, each of said plurality of door actuators being positioned beneath a respective one of said plurality of hopper doors, each of said door actuators being coupled to a respective one of said hopper doors, each of said door actuators being electrically coupled to said control processor, each of said plurality of door actuators being individually actuatable into an opening condition such that door actuator that is actuated into said opening condition urges said respective hopper door into said open position, each of said plurality of door actuators being individually actuatable into a closing condition such that said door actuator that is actuated into said closing condition urges said respective hopper door into said closed position.

5. The device according to claim 4, wherein said cooking unit comprises:
an oil reservoir being slidably positioned in said cooking housing wherein said oil reservoir is configured to contain cooking oil, said oil reservoir oil reservoir being aligned with said oil opening in said back side of said outer wall of said cooking housing such that said oil reservoir is slidable outwardly through said oil opening for filling or servicing said oil reservoir, said oil reservoir being positioned beneath said plurality of hoppers; and
an oil heater being attached to said bottom wall of said cooking housing such that said oil heater is positioned inside of said cooking housing, said oil reservoir lying on said oil heater when said oil reservoir is positioned in said cooking housing, said oil heater being in thermal communication with a bottom wall of said oil reservoir when said oil reservoir is positioned on said oil heater thereby facilitating said oil heater to heat said oil reservoir wherein said oil heater is configured to heat the oil in said oil reservoir, said oil heater being electrically coupled to said control processor.

6. The device according to claim 5, wherein:
said cooking unit comprises a plurality of fry baskets, each of said plurality of fry baskets being slidably positioned within said cooking housing, each of said plurality of fry baskets being positioned beneath a respective one of said plurality of hoppers wherein each of said plurality of fry baskets is configured to receive the French fries from said respective hopper; each of said plurality of fry baskets has a forward side being open;
each of said plurality of fry baskets has a fry door being hingedly disposed on said forward side, said fry door being positionable in an open position wherein said forward side is configured to release the French fries from said forward side, said fry door being positionable in a closed position wherein said fry door is configured to inhibit the French fries from passing through said forward side;
said plurality of fry baskets has a unique size with respect to each other ranging between a small size and a medium size and a large size; and
said cooking unit includes a plurality of basket transports, each of said plurality of basket transports being positioned within said cooking housing, each of said plurality of fry baskets being attached to a respective one of said plurality of basket transports for lowering said respective fry basket into said oil reservoir wherein said respective fry basket is configured to cook the French fries in said oil reservoir, said plurality of basket transports being spaced apart from each other and being evenly distributed along said back side of said outer wall of said cooking housing.

7. The device according to claim 6, wherein each of said plurality of basket transports comprises:
a basket track being mounted to said back side of said outer wall of said cooking housing such that said basket track is positioned within said cooking housing, said basket track being oriented to extend between a respective one of said plurality of fry baskets and a respective one of said plurality of hoppers; and
a basket actuator including a first arm being pivotally coupled to a second arm, said second arm being pivotally attached to a respective one of said fry baskets;
said basket actuator includes a first drive being attached to said first arm having said first drive being positioned in said basket track, said first drive being electrically coupled to said control processor, said first drive being actuated to either lift or lower said first arm along said backet track thereby lifting said respective fry basket out of said cooking oil or lowering said respective fry basket into said cooking oil;
said basket actuator includes a second drive being attached to said second arm, said second drive being electrically coupled to said control processor, said second drive urging said second arm between a cooking position and a dumping position, said second arm angling upwardly from said first arm when said second arm is in said cooking position thereby positioning said respective fry basket in a horizontal orientation, said second arm angling forwardly from said first arm when said second arm is in said dumping position thereby positioning said respective fry basket in a downwardly sloped position; and
said fry door on said respective fry basket is urged into said open position when said second arm is positioned in said dumping position, said fry door on said respective fry basket being biased into said closed position when said second arm is positioned in said cooking position.

8. The device according to claim 6, wherein:
said device includes a plurality of weight sensors;
each of said plurality of weight sensors is attached to a respective one of said plurality of fry baskets thereby facilitating each of said weight sensors to sense the weight of said respective fry basket wherein each of said plurality of weight sensors is configured to sense the combined weight of said respective fry basket and the French fries released into said respective fry basket; and
each of said plurality of weight sensors is electrically coupled to said control processor.

9. The device according to claim 8, wherein:
said door actuator that is aligned with said small size fry basket is actuated into said open condition when said control processor receives said small input wherein said small size fry basket is configured to be filled with French fries;
said door actuator aligned with said small size fry basket is actuated into said closed condition when said control processor receives said close input; and
said control processor receives said close input when said weight sensor attached to said small size fry basket senses the combined weight of said small size fry basket and the French fries reaches said small weight stored in said electronic memory.

10. The device according to claim 8, wherein:
said door actuator that is aligned with said medium size fry basket is actuated into said open condition when said control processor receives said medium input wherein said medium size fry basket is configured to be filled with French fries;
said door actuator aligned with said medium size fry basket is actuated into said closed condition when said control processor receives said close input; and
said control processor receives said close input when said weight sensor attached to said medium size fry basket senses the combined weight of said medium size fry basket and the French fries reaches said medium weight stored in said electronic memory.

11. The device according to claim 8, wherein
said door actuator that is aligned with said large size fry basket is actuated into said open condition when said control processor receives said large input wherein said large size fry basket is configured to be filled with French fries;
said door actuator aligned with said large size fry basket is actuated into said closed condition when said control processor receives said close input; and
said control processor receives said close input when said weight sensor attached to said large size fry basket senses the combined weight of said large size fry basket and the French fries reaches said large weight stored in said electronic memory.

12. The device according to claim 6, wherein:
each of said plurality of dispensing chutes extends downwardly from said bottom wall of said cooking housing;
each of said dispensing chutes is aligned with a respective one of said fry baskets wherein each of said plurality of dispensing chutes is configured to receive the French fries from said respective fry basket; and
each of said dispensing chutes extends upwardly through said bottom wall of said cooking housing such that an upper end of each of said plurality of dispensing chutes is positioned inside of said cooking housing.

13. The device according to claim 12, wherein:
each of said plurality of dispensing chutes includes a ramp angling between said upper end of said dispensing chutes and said respective fry basket wherein said ramp on a respective dispensing chute is configured to direct the French fries from said respective fry basket into said respective dispensing chute;
each of said plurality of dispensing chutes is tapered adjacent to a distal end of said plurality of dispensing chutes; and
said plurality of dispensing chutes is spaced apart from each other and is distributed along said front side of said outer wall of said cooking housing.

14. The device according to claim 1, wherein:
said cooking housing has an outer wall which has a first lateral side; and
said box dispenser comprises:
a plurality of supports, each of said supports being coupled to and extending away from a first lateral side of an outer wall of said cooking housing;
a box housing having a rear wall being attached to a distal end of each of said plurality of supports such that said box housing is spaced from said cooking housing;
said box housing has a bottom end being open into an interior of said box housing;
said box housing has a top end being open into said interior of said box housing thereby facilitating said box housing to be filled with a stack of said small boxes and a stack of said medium boxes and a stack of said large boxes; and
said box housing has a lid being movably disposed on said top end of said box housing for opening and closing said top end of said box housing.

15. The device according to claim 14, wherein:
said device includes a control processor;
said box dispenser includes a plurality of box actuators;
each of said plurality of box actuators is attached to said rear wall of said box housing;
each of said plurality of box actuators is electrically coupled to said control processor;
each of said plurality of box actuators is aligned with a respective one of said stack of small boxes or said stack of medium boxes or said stack of large boxes;
each of said plurality of said box actuators includes a piston being urgeable downwardly from a respective box actuator when said respective box actuator is actuated into a first condition;
each of said plurality of box actuators includes a grip being attached to a distal end of said piston of a respective box actuator;
said grip of each of said plurality of box actuators engages a bottommost one of a respective one of said stack of small boxes or said stack of medium boxes or said stack of large boxes when a respective box actuator is actuated into a second condition; and
said piston of a respective box actuator is rotated to position said grip in a releasing position when said respective box actuator is actuated into a third condition.

16. The device according to claim 15, wherein said conveyor unit comprises:
a track support being continuous such that said track support forms a closed loop, said track support having a basal wall and a pair of outer walls extending upwardly from said basal wall, said track support extending around said stand having each of said outer walls being directed upwardly toward said cooking housing;
a conveyor belt being positioned on said basal wall of said track support, said conveyor belt being continuous such that said conveyor belt extends around said closed loop defined by said track support;
a plurality of boxes, each of said plurality of boxes being coupled to and extending upwardly from said conveyor belt, said plurality of boxes being spaced apart from each other and being evenly distributed along said conveyor belt;
a respective one of said plurality of box actuators places a respective one of said small box or said medium box or said large box into a respective one of said boxes on said conveyor belt thereby facilitating said conveyor belt to transport said respective small box or medium box or large box around said cooking housing; and
a conveyor motor being attached to said track support, said conveyor motor being in mechanical communication with said conveyor belt, said conveyor motor urging said conveyor belt to travel around said track support when said conveyor motor is turned on, said conveyor motor being electrically coupled to said control processor.

17. The device according to claim 1, wherein:
said device includes a control housing;
said device includes a control processor being positioned within said control housing, said control processor receiving a small input and a medium input and a large input;
said touch screen displays indicia comprising a plurality of words and icons associated with said small order of French fries and said medium order of French fries and said large order of French fries wherein said plurality of words and icons is configured to facilitate the employee to order said small order of French fries or said medium order of French fries or said large order of French fries;
said touch screen is electrically coupled to said control processor;
said control processor receives said small input when said touch screen is employed to order a small order of French fries;
said control processor receives said medium input when said touch screen is employed to order a medium order of French fries; and
said control processor receives said large input when said touch screen is employed to order a large order of French fries.

18. The device according to claim 1, wherein:
said device includes a heat lamp being attached to said cooking housing;
said heat lamp is elongated to extend around a full perimeter of said cooking housing;
said heat lamp is positioned above said conveyor unit wherein said heat lamp is configured to emit infra-red radiation onto the French fries being transported by said conveyor unit for retaining the French fries on said conveyor unit at a preferred temperature;
said heat lamp includes a lamp housing having a top wall and an outside wall extending downwardly from said top wall of said lamp housing;
a rear edge of said top wall of said lamp housing is attached to an outer wall of said cooking housing having said top wall of said lamp housing extending around said outer wall of said cooking housing;
said outer wall of said lamp housing angles away from said outer wall of said cooking housing;
said outer wall of said lamp housing has a lower edge defining an opening into said lamp housing being directed toward said conveyor belt; and
said heat lamp includes an emitter being disposed within said lamp housing wherein said emitter is configured to emit infra-red radiation outwardly through said opening defined in said lamp housing.

19. An automated French fry device for cooking and dispensing French fries based on a employee's input, said device comprising:
a cooking housing being mounted upon a stand wherein said stand is configured to support said cooking housing over a support surface, said cooking housing having a plurality of dispensing chutes each extending downwardly from said cooking housing, said stand comprising a base and a pair of legs each extending upwardly from said base, said cooking housing having a bottom wall, a top wall and an outer wall extending between said top wall and said bottom wall, said bottom wall being attached to a top end of said pair of legs, each of said plurality of dispensing chutes extending through said bottom wall of said cooking housing such that a distal end of each of said plurality of dispensing chutes is positioned beneath said bottom wall, each of said plurality of dispensing chutes having a unique length with respect to each other, said top wall having an access opening extending into an interior of said cooking housing, a back side of said outer wall having an oil opening extending into said interior of said cooking housing;
a touch screen being mounted to said cooking housing wherein said touch screen is configured to be touched by a employee for ordering French fries;
a plurality of hoppers, each of said plurality of hoppers being positioned inside of said cooking housing wherein each of said plurality of hoppers is configured to contain French fries, each of said plurality of hoppers being aligned with said access opening in said top wall of said cooking hopper wherein said access opening is configured to facilitate each of said plurality of hoppers to be filled with French fries, each of said hoppers having a bottom end being open wherein said bottom end of each of said plurality of hoppers is configured to dispense the French fries, an interior surface of each of said plurality of hoppers tapering inwardly adjacent to said bottom end wherein said interior surface of each of said plurality of hoppers is configured to enhance efficiency of releasing the French fries from said plurality of hoppers, each of said plurality of hoppers having a top end being open wherein said top end of each of said plurality of hoppers is configured to receive the French fries;
a control housing being positioned within said cooking housing, said control housing being positioned between said plurality of hoppers and a front side of said outer wall of said cooking housing;
a dispensing unit being integrated into said cooking housing, said dispensing unit being in communication with each of said plurality of hoppers, said dispensing unit being actuatable to dispense a small order of French fries or a medium order of French fries or a large order of French fries from a respective one of said plurality of hoppers, said dispensing unit comprising:
a control processor being positioned within said control housing, said control processor receiving a small input and a medium input and a large input and a close input, said control processor including an electronic memory which stores a small weight and a medium weight and a large weight;
a plurality of hopper doors, each of said hopper doors being slidably positioned on a lower wall of said control housing, each of said hopper doors being aligned with said bottom end of a respective one of said plurality of hoppers, each of said plurality of hopper doors being positionable in a closed position having each of said plurality of hopper doors extending across said bottom end of a respective one of said plurality of hoppers wherein said plurality of hopper doors is configured to inhibit the French fries from being dispensed from said respective hopper, each of said plurality of hopper doors being positionable in an open position having said each of said plurality of hopper doors being displaced from said bottom end of said respective hopper wherein said each of said plurality of hopper doors is configured to facilitate the French fries to be dispensed from said bottom end of said respective hopper; and
a plurality of door actuators, each of said door actuators being mounted in said cooking housing, each of said plurality of door actuators being positioned beneath a respective one of said plurality of hopper doors, each of said door actuators being coupled to a respective one of said hopper doors, each of said door actuators being electrically coupled to said control processor, each of said plurality of door actuators being individually actuatable into an opening condition such that door actuator that is actuated into said opening condition urges said respective hopper door into said open position, each of said plurality of door actuators being individually actuatable into a closing condition such that said door actuator that is actuated into said closing condition urges said respective hopper door into said closed position;
a cooking unit being integrated into said cooking housing, said cooking unit receiving said small order of French fries or said medium order of French fries or said large order of French fries from said dispensing unit thereby facilitating said cooking unit to cook said small order of French fries or said medium order of French fries or said large order of French fries, said cooking unit being actuated to release said small order of French fries or said medium order of French fries or said large order of French fries into said a respective one of said plurality of dispensing chutes, said cooking unit comprising:
an oil reservoir being slidably positioned in said cooking housing wherein said oil reservoir is configured to contain cooking oil, said oil reservoir oil reservoir being aligned with said oil opening in said back side of said outer wall of said cooking housing such that said oil reservoir is slidable outwardly through said oil opening for filling or servicing said oil reservoir, said oil reservoir being positioned beneath said plurality of hoppers;
an oil heater being attached to said bottom wall of said cooking housing such that said oil heater is positioned inside of said cooking housing, said oil reservoir lying on said oil heater when said oil reservoir is positioned in said cooking housing, said oil heater being in thermal communication with a bottom wall of said oil reservoir when said oil reservoir is positioned on said oil heater thereby facilitating said oil heater to heat said oil reservoir wherein said oil heater is configured to heat the oil in said oil reservoir, said oil heater being electrically coupled to said control processor;
a plurality of fry baskets, each of said plurality of fry baskets being slidably positioned within said cooking housing, each of said plurality of fry baskets being positioned beneath a respective one of said plurality of hoppers wherein each of said plurality of fry baskets is configured to receive the French fries from said respective hopper, each of said plurality of fry baskets having a forward side being open, each of said plurality of fry baskets having a fry door being hingedly disposed on said forward side, said fry door being positionable in an open position wherein said forward side is configured to release the French fries from said forward side, said fry door being positionable in a closed position wherein said fry door is configured to inhibit the French fries from passing through said forward side, said plurality of fry baskets having a unique size with respect to each other ranging between a small size and a medium size and a large size;
a plurality of basket transports, each of said plurality of basket transports being positioned within said cooking housing, each of said plurality of fry baskets being attached to a respective one of said plurality of basket transports for lowering said respective fry basket into said oil reservoir wherein said respective fry basket is configured to cook the French fries in said oil reservoir, said plurality of basket transports being spaced apart from each other and being evenly distributed along said back side of said outer wall of said cooking housing, each of said plurality of basket transports comprising:
a basket track being mounted to said back side of said outer wall of said cooking housing such that said basket track is positioned within said cooking housing, said basket track being oriented to extend between a respective one of said plurality of fry baskets and a respective one of said plurality of hoppers; and
a basket actuator including a first arm being pivotally coupled to a second arm, said second arm being pivotally attached to a respective one of said fry baskets, said basket actuator including a first drive being attached to said first arm having said first drive being positioned in said basket track, said first drive being electrically coupled to said control processor, said first drive being actuated to either lift or lower said first arm along said backet track thereby lifting said respective fry basket out of said cooking oil or lowering said respective fry basket into said cooking oil, said basket actuator including a second drive being attached to said second arm, said second drive being electrically coupled to said control processor, said second drive urging said second arm between a cooking position and a dumping position, said second arm angling upwardly from said first arm when said second arm is in said cooking position thereby positioning said respective fry basket in a horizontal orientation, said second arm angling forwardly from said first arm when said second arm is in said dumping position thereby positioning said respective fry basket in a downwardly sloped position, said fry door on said respective fry basket being urged into said open position when said second arm is positioned in said dumping position, said fry door on said respective fry basket being biased into said closed position when said second arm is positioned in said cooking position;
a plurality of weight sensors, each of said plurality of weight sensors being attached to a respective one of said plurality of fry baskets thereby facilitating each of said weight sensors to sense the weight of said respective fry basket wherein each of said plurality of weight sensors is configured to sense the combined weight of said respective fry basket and the French fries released into said respective fry basket, each of said plurality of weight sensors being electrically coupled to said control processor, said door actuator that is aligned with said small size fry basket being actuated into said open condition when said control processor receives said small input wherein said small size fry basket is configured to be filled with French fries, said door actuator aligned with said small size fry basket being actuated into said closed condition when said control processor receives said close input, said control processor receiving said close input when said weight sensor attached to said small size fry basket senses the combined weight of said small size fry basket and the French fries reaches said small weight stored in said electronic memory, said door actuator that is aligned with said medium size fry basket being actuated into said open condition when said control processor receives said medium input wherein said medium size fry basket is configured to be filled with French fries, said door actuator aligned with said medium size fry basket being actuated into said closed condition when said control processor receives said close input, said control processor receiving said close input when said weight sensor attached to said medium size fry basket senses the combined weight of said medium size fry basket and the French fries reaches said medium weight stored in said electronic memory, said door actuator that is aligned with said large size fry basket being actuated into said open condition when said control processor receives said large input wherein said large size fry basket is configured to be filled with French fries, said door actuator aligned with said large size fry basket being actuated into said closed condition when said control processor receives said close input, said control processor receiving said close input when said weight sensor attached to said large size fry basket senses the combined weight of said large size fry basket and the French fries reaches said large weight stored in said electronic memory;
wherein each of said plurality of dispensing chutes extends downwardly from said bottom wall of said cooking housing, each of said dispensing chutes being aligned with a respective one of said fry baskets wherein each of said plurality of dispensing chutes is configured to receive the French fries from said respective fry basket, each of said dispensing chutes extending upwardly through said bottom wall of said cooking housing such that an upper end of each of said plurality of dispensing chutes is positioned inside of said cooking housing, each of said plurality of dispensing chutes including a ramp angling between said upper end and said respective fry basket wherein said ramp on a respective dispensing chute is configured to direct the French fries from said respective fry basket into said respective dispensing chute, each of said plurality of dispensing chutes being tapered adjacent to said distal end of said plurality of dispensing chutes, said plurality of dispensing chutes being spaced apart from each other and being distributed along said front side of said outer wall of said cooking housing;
a box dispenser being attached to said cooking housing, said box dispenser containing a plurality of small boxes and a plurality of medium boxes and a plurality of large boxes, said box dispenser releasing one of said small boxes or one of said medium boxes or one of said large boxes depending upon the order that is entered on said touch screen thereby facilitating said small box or said medium box or said large box to receive said small order of French fries or said medium order of French fries or said large order of French fries, said box dispenser comprising:
a plurality of supports, each of said supports being coupled to and extending away from a first lateral side of said outer wall of said cooking housing;
a box housing having a rear wall being attached to a distal end of each of said plurality of supports such that said box housing is spaced from said cooking housing, said box housing having a bottom end being open into an interior of said box housing, said box housing having a top end being open into said interior of said box housing thereby facilitating said box housing to be filled with a stack of said small boxes and a stack of said medium boxes and a stack of said large boxes, said box housing having a lid being movably disposed on said top end of said box housing for opening and closing said top end of said box housing; and
a plurality of box actuators, each of said plurality of box actuators being attached to said rear wall of said box housing, each of said plurality of box actuators being electrically coupled to said control processor, each of said plurality of box actuators being aligned with a respective one of said stack of small boxes or said stack of medium boxes or said stack of large boxes, each of said plurality of said box actuators including a piston being urgeable downwardly from a respective box actuator when said respective box actuator is actuated into a first condition, each of said plurality of box actuators including a grip being attached to a distal end of said piston of a respective box actuator, said grip of each of said plurality of box actuators engaging a bottommost one of a respective one of said stack of small boxes or said stack of medium boxes or said stack of large boxes when a respective box actuator is actuated into a second condition, said piston of a respective box actuator being rotated to position said grip in a releasing position when said respective box actuator is actuated into a third condition;
a conveyor unit being movably attached to said stand, said conveyor unit being positioned beneath said cooking housing, said conveyor unit receiving said small box or said medium box or said large box released from said box dispenser, said conveyor unit being aligned with said plurality of dispensing chutes thereby facilitating said small box or said medium box or said large box to receive a corresponding one of said small order of French fries or said medium order of French fries or said large order of French fries from a respective one of said dispensing chutes wherein said conveyor unit is configured to facilitate the employee to receive said small order of French fries or said medium order of French fries or said large order of French fries, said conveyor unit comprising:
a track support being continuous such that said track support forms a closed loop, said track support having a basal wall and a pair of outer walls extending upwardly from said basal wall, said track support extending around said stand having each of said outer walls being directed upwardly toward said cooking housing;
a conveyor belt being positioned on said basal wall of said track support, said conveyor belt being continuous such that said conveyor belt extends around said closed loop defined by said track support;
a plurality of boxes, each of said plurality of boxes being coupled to and extending upwardly from said conveyor belt, said plurality of boxes being spaced apart from each other and being evenly distributed along said conveyor belt, a respective one of said plurality of box actuators placing a respective one of said small box or said medium box or said large box into a respective one of said boxes on said conveyor belt thereby facilitating said conveyor belt to transport said respective small box or medium box or large box around said cooking housing; and
a conveyor motor being attached to said track support, said conveyor motor being in mechanical communication with said conveyor belt, said conveyor motor urging said conveyor belt to travel around said track support when said conveyor motor is turned on, said conveyor motor being electrically coupled to said control processor;
wherein said touch screen is in communication with each of said dispensing unit and said and said cooking unit and said conveyor unit wherein said touch screen is configured to facilitate the employee to order and subsequently receive said small order of French fries or said medium order of French fries or said large order of French fries, said touch screen displaying indicia comprising a plurality of words and icons associated with said small order of French fries and said medium order of French fries and said large order of French fries wherein said plurality of words and icons is configured to facilitate the employee to order said small order of French fries or said medium order of French fries or said large order of French fries, said touch screen being electrically coupled to said control processor, said control processor receiving said small input when said touch screen is employed to order a small order of French fries, said control processor receiving said medium input when said touch screen is employed to order a medium order of French fries, said control processor receiving said large input when said touch screen is employed to order a large order of French fries;
a heat lamp being attached to said cooking housing, said heat lamp being elongated to extend around a full perimeter of said cooking housing, said heat lamp being positioned above said conveyor unit wherein said heat lamp is configured to emit infra-red radiation onto the French fries being transported by said conveyor unit for retaining the French fries on said conveyor unit at a preferred temperature, said heat lamp including a lamp housing having a top wall and an outside wall extending downwardly from said top wall of said lamp housing, a rear edge of said top wall of said lamp housing being attached to said outer wall of said cooking housing having said top wall of said lamp housing extending around said outer wall of said cooking housing, said outside wall of said lamp housing angling away from said outer wall of said cooking housing, said outside wall of said lamp housing having a lower edge defining an opening into said lamp housing being directed toward said conveyor belt, said heat lamp including an emitter being disposed within said lamp housing wherein said emitter is configured to emit infra-red radiation outwardly through said opening defined in said lamp housing, said emitter being electrically coupled to said control processor; and
a power cord being coupled to and extending away from said control housing, said power cord being electrically coupled to said control processor, said power cord having a male plug being electrically coupled to a distal end of said power cord wherein said male plug is configured to be plugged into a power source comprising a female electrical outlet.
